(19) United States
(12) Patent Application Publication
(10) Pub. No.: US 2025/0252372 A1
(43) Pub. Date: Aug. 7, 2025

(54) SYSTEM AND METHOD FOR GENERATING AND PROVIDING UNIFIED WORKSPACE LEVEL ALERTS BASED ON ONE OR MORE CONTEXTS

(71) Applicant: Dell Products, LP, Round Rock, TX (US)

(72) Inventors: Vivekanandh Narayanasamy Rajagopalan, Bangalore (IN); Gokul Thiruchengode Vajravel, Banglaore (IN); Vivek Viswanathan Iyer, Saint Johns, FL (US)

(73) Assignee: Dell Products, LP, Round Rock, TX (US)

(21) Appl. No.: 18/430,340

(22) Filed: Feb. 1, 2024

(51) Int. Cl. G06Q 10/0631

(52) U.S. Cl. CPC G06Q 10/06314

(57) ABSTRACT

A peripheral device workspace cloud orchestrator server includes a hardware processor and a network interface device to receive quality of experience (QoE) values associated with a plurality of device nodes within a workspace. The hardware processor executes computer-readable program code of a peripheral device workspace telemetry module to save the QoE values, user identification data, and node device data on a cloud orchestrator database. The hardware processor executes the computer code of a peripheral device workspace telemetry module to request and receive upcoming user meetings and events associated with the user's use of the plurality of device nodes that are affected by the QoE values and generate unified workspace notifications that the QoE will be affected at one or more of the device nodes within the workspace and sending those unified workspace notifications to the anchor information handling system node within the workspace.

### FIELD OF THE DISCLOSURE

The present disclosure relates to automatically generating and providing unified workspace level alerts based on one or more contexts. The present disclosure more specifically relates to automatically generating and providing, to a device node within a peripheral device workspace, unified workspace level alerts based on one or more contexts that affect the quality of experience (QoE) within the peripheral device workspace.

### BACKGROUND

As the value and use of information continues to increase, individuals and businesses seek additional ways to process and store information. One option available to clients is information handling systems. An information handling system processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more applications such as a gaming application. Further, the information handling system may include a plurality of peripheral devices that are identifiable by a server operatively coupled to the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system operatively coupled to a remotely located peripheral device workspace cloud orchestrator server according to an embodiment of the present disclosure;

FIG. 2 is a graphic diagram of an anchor information handling system node 200 operatively coupled to a remotely located peripheral device workspace cloud orchestrator server of a peripheral device workspace cloud orchestrator according to an embodiment of the present disclosure;

FIG. 3 is a flow chart showing a method of providing unified workspace notifications to a device node within a peripheral device workspace according to an embodiment of the present disclosure; and

FIG. 4 is a flow chart showing a method of providing unified workspace level alerts to a device node within a peripheral device workspace according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

A user may oftentimes use an information handling system in a peripheral device workspace. In this context, a peripheral device workspace can be viewed as an environment that includes a user information handling system (e.g., a laptop) as one possible anchor node (e.g., anchor information handling system node) and one or more peripheral devices also referred to as peripherals or device nodes that are connected to the user information handling system. In an embodiment, each of the information handling system and peripherals may be referred to as device nodes. An environmental context may be determined for a formed peripheral device workspace and may include, for example, physical location, networked location, time of day, applications being executed, wireless or wired connection capabilities, security credentials for a user, user identification, and other factors. Node devices may commonly include, in some embodiments, internal or external devices such as video display devices, a keyboard, a mouse, a webcam, a printer, a speaker, a fingerprint scanner, a trackpad, and a stylus, among others that may be integrated peripheral devices in an anchor information handling system node (e.g., a laptop) or separate, external peripheral device nodes operatively coupled to the anchor information handling system node via a wired or wireless connection. Oftentimes, a peripheral device workspace may include a wired or wireless dock as at least one example of a smart node by which the user information handling system connects to some or all the secondary, external node devices including other smart node devices having some compute or input/output (networking) capabilities. Such smart devices may operate as backup or replace the user information handling system as an anchor node in the peripheral device workspace in some embodiments herein.

According to embodiments herein, a formed peripheral device workspace may oftentimes be used for hybrid work scenarios. For example, a business may have an office space that includes hoteling cubes that can be assigned to, reserved by, or otherwise utilized by the business' employees as peripheral device workspaces for use with one or more peripheral devices and an information handling system introduced to the peripheral device workspace for the duration it is used by the identified user such as a business' employee. In such an example case, the business may allow its individual employees to connect their laptops to a dock in a particular hoteling cube having a formed peripheral device workspace where various external peripherals may be available for use. Users may also employ other peripheral device workspaces when working from home or other locations and the information handling system and some portion of the external peripheral devices may travel with the user to one or more of the identified peripheral device workspaces that a particular user may enter and use.

When a user employs multiple peripheral device workspaces (e.g., by connecting a laptop to different combinations of peripherals during a workday at different locations), it can be tedious for the user to configure any of the other peripheral devices in each of the peripheral device workspaces to his or her preferences. For example, while using one peripheral device workspace, the user may set configurations for the peripherals of the peripheral device workspace to match the user's preferences. If the user switches to a different peripheral device workspace, those configurations may not be consistent with the peripherals of the different peripheral device workspace or may result in unintended changes. This is particularly true of those peripheral device workspaces where a user may share the peripheral device workspace with other users. Additionally, the peripheral device workspaces may serve different purposes for the user or require different settings for one or more nodes in each defined peripheral device workspace. The user may therefore have to manually reconfigure the peripheral device workspace upon entering each new peripheral device workspace.

Still further, changes to the peripheral device workspace may occur when, for example, a node device requires firmware/software updates, old node devices are removed from the peripheral device workspace, new node devices are added to the peripheral device workspace, or changes in the compliance of these node devices relative to hardware device operational policies provided to the node devices from an internet technology decision maker (ITDM) occur. Such ITDM established hardware device operational policies may be set to determine how a node device may perform within the peripheral device workspace in some example embodiments. How the node device may perform within the peripheral device workspace may depend on the environment of the peripheral device workspace, the risks of security any given node device poses within the peripheral device workspace, and what the capabilities or configurations of any given node device are as well as aspects of the user's needs upon entering such a peripheral device workspace.

Even further, the quality of experience (QoE) realized within a given peripheral device workspace may be affected by the individual peripheral device nodes registered within the peripheral device workspace. For example, some peripheral device nodes may be powered using direct current (DC) via a battery source that may be depleted over time resulting in a user not being able to use that particular peripheral device node. For example, a wireless mouse may be operated using a rechargeable battery that, over time, may be depleted resulting the in user having to recharge the rechargeable battery which takes time and results in the inability to use the wireless mouse during the recharging process. Still further, other nodes may similarly have limited resources such as processing resources, memory resources, and other resources that, when overburdened during operation. For example, a smart device node may include a processing resource that may not be capable to processing additional computations or operations thereby limiting the ability of the user to quickly execute computer-readable program code or otherwise results in the throttled processing, overclocking of the hardware processor resulting in increased heat production at the hardware processor, and the like which may affect the user's productivity within the peripheral device workspace.

In order to reduce QoE affects the systems and methods described herein may provide unified workspace notifications that inform the user within the peripheral device workspace of potential QoE issues that is or will arise. In an embodiment, a peripheral device workspace cloud orchestrator server may execute computer-readable program code of a peripheral device workspace telemetry module that saves and maintains a list of QoE values, user identification data, and node device data on a cloud orchestrator database associated with the peripheral device workspace cloud orchestrator server. The QoE values, user identification data, and node device data is received from, in an embodiment, an anchor information handling system within a peripheral device node when the peripheral device node has executed, with a hardware processing device, computer-readable program code of an ecosystem manageability sub-agent. The execution of the ecosystem manageability sub-agent by the hardware processing device of the anchor information handling system node causes the anchor information handling system node to gather these QoE values, user identification data, and node device data for transmission to the peripheral device workspace cloud orchestrator server as described. When the peripheral device workspace cloud orchestrator server has received these QoE values, user identification data, and node device data on a cloud orchestrator database, the peripheral device workspace cloud orchestrator server executes computer-readable program code of a peripheral device workspace telemetry module to, at least initially, request and receive upcoming user meetings and events associated with the user's use of the plurality of device nodes that are affected by the QoE values. These user meetings may include those meetings and events that are scheduled on a calendaring system (e.g., Microsoft® Outlook®) or otherwise known to occur by the peripheral device workspace cloud orchestrator server. The user events may include the execution of certain computer-readable program code such as a gaming application or design program that requires a significant amount of processing power to operate on an anchor information handling system node and thus may overburden the hardware processing device within the anchor information handling system node or other smart device node within the peripheral device workspace. As such the hardware processing device of the peripheral device workspace cloud orchestrator server may execute computer-readable program code of the peripheral device workspace telemetry module to analyze these trends in relation to the meetings and events and provide projections indicative of the QoE values affecting the QoE during the meetings and events. When the peripheral device workspace cloud orchestrator server determines that the QoE will be affected within the peripheral device workspace as a result of the consumption of resources within the peripheral device workspace, the execution of the computer-readable program code of a peripheral device workspace telemetry module may direct that a unified workspace notification be generated that indicate the QoE will be affected at one or more of the device nodes within the workspace and send those unified workspace notifications to the anchor information handling system node within the peripheral device workspace.

In an embodiment, the hardware processor of the cloud peripheral device workspace orchestrator server may also execute computer-readable program code of an ecosystem manageability service module. Execution of computer-readable program code for the ecosystem manageability service module via the peripheral device workspace cloud orchestrator server causes the hardware device operational policies to be applied to the created peripheral device workspace in order to propagate those policies generated by an internet technology decision maker (ITDM) at a peripheral device workspace cloud orchestrator consol graphical user interface. In an embodiment, the cloud peripheral device workspace manageability orchestrator module creates hardware device operational policies for each of the one or more node devices within the peripheral device workspace based on received hardware device operational policies created by an ITDM and received at the cloud peripheral device workspace orchestrator server via the cloud peripheral device workspace orchestrator consol graphical user interface.

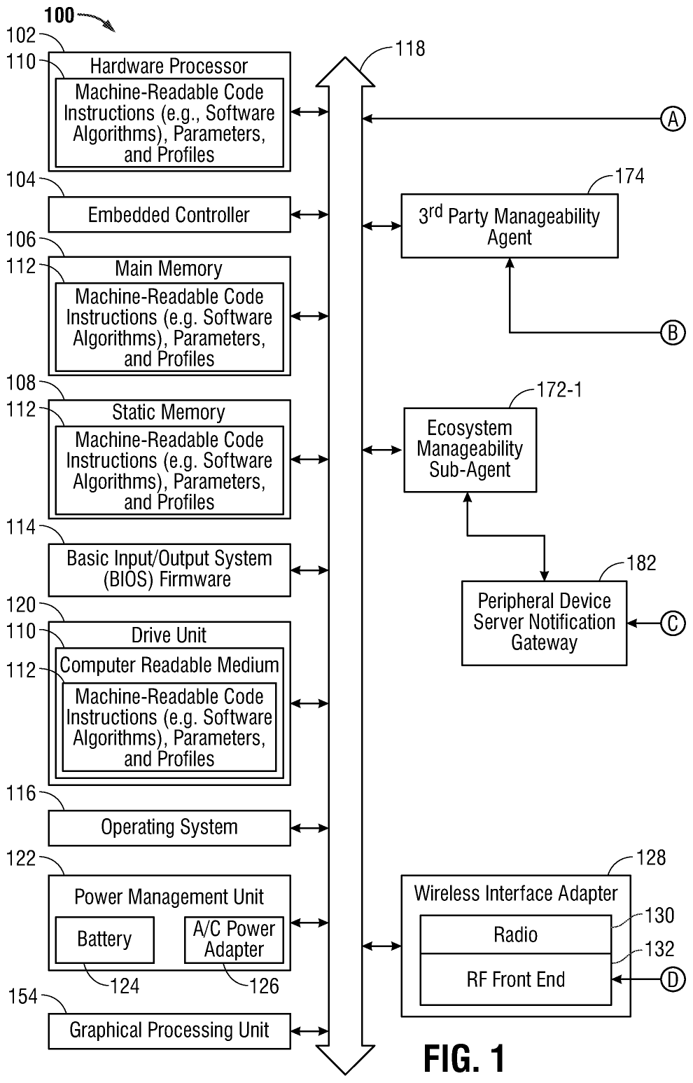

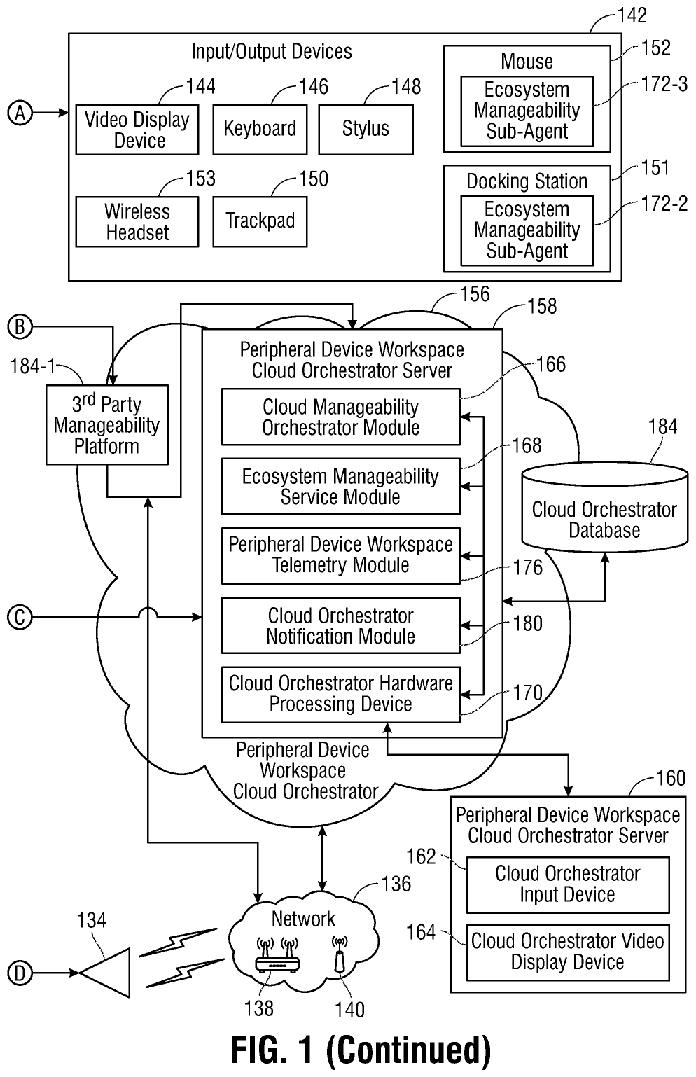

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 138, a base station transceiver 140, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality. It is appreciated that, in some embodiments herein, the information handling system 100 may be one of a plurality of device nodes as part of a peripheral device workspace or a peripheral device workspace cloud orchestrator server 158 that are operatively coupled to a peripheral device workspace cloud orchestrator consol 160 graphical user interface in the peripheral device workspace cloud orchestrator 156 described herein. It is further appreciated that the information handling system 100 described herein may be referred to as an anchor information handling system 100. In an embodiment, the cloud orchestrator consol 160 graphical user interface may be an information handling system itself as described herein that is used by an internet technology decision maker (ITDM) to create hardware device operational policies with one or more peripheral device workspace cloud orchestrator servers 158 to be propagated down to node devices within a peripheral device workspace such as the information handling system 100, a docking station 151, video display device 144, keyboard 146, stylus 148, trackpad 150, mouse 152, and the like. In this embodiment, the information handling system 100, may receive the hardware device operational policies generated by the ITDM at the peripheral device workspace cloud orchestrator consol 160 graphical user interface via execution of code instructions of the cloud manageability orchestrator module 166 and the ecosystem manageability service module 168 at the peripheral device workspace cloud orchestrator server 158 as described in embodiments herein.

Thus, in a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 106, (volatile (e.g., random-access memory, etc.), or static memory 108, nonvolatile (read-only memory, flash memory etc.) or any combination thereof), one or more hardware processing resources, such as a hardware processor 102 that may be a central processing unit (CPU), a graphics processing unit (GPU) 103, embedded controller (EC) 104, or any combination thereof. Additional components of the information handling system 100 may include one or more storage devices such as static memory 108 or drive unit 120. The information handling system 100 may include or interface with one or more communications ports for communicating with external devices, as well as various input and output (I/O) devices 142, such as a docking station 151, a mouse 152, a trackpad 150, a keyboard 146, a stylus 148, a video/graphics display device 144, a docking station 151 or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 112 that may operate on servers or systems, remote data centers, or on-box in individual client information handling systems according to various embodiments herein. In some embodiments, it is understood any or all portions of instructions (e.g., software algorithms), parameters, and profiles 112 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 106, static memory 108, and disk drive unit 120 (volatile (e.g., random-access memory, etc.), nonvolatile memory (read-only memory, flash memory etc.) or any combination thereof or other memory with computer readable medium 110 storing instructions (e.g., software algorithms), parameters, and profiles 112 executable by the EC 104, hardware processor 102, GPU 103, or any other hardware processing device. The information handling system 100 may also include one or more buses 118 operable to transmit communications between the various hardware components such as any combination of various I/O devices 142 as well as between hardware processors 102, an EC 104, the operating system (OS) 116, the basic input/output system (BIOS) 114, the wireless interface adapter 128, or a radio module, among other components described herein. In an embodiment, the information handling system 100 may be in wired or wireless communication with the I/O devices 142 such as a docking station 151, a keyboard 146, a mouse 152, video display device 144, stylus 148, a docking station 151, or trackpad 150 among other peripheral devices.

The information handling system 100 further includes a video/graphics display device 144. The video/graphics display device 144 in an embodiment may function as a liquid crystal display (LCD), an organic light emitting diode (OLED), a flat panel display, or a solid-state display. It is appreciated that the video/graphics display device 144 may be wired or wireless and may be an external video/graphics display device 144 that allows a user to increase the desktop area by extending the desktop in an embodiment. Additionally, as described herein, the information handling system 100 may include or be operatively coupled to one or more other I/O devices 142 including a wired or wireless mouse 152 that allows the user to interface with the information handling system 100 via the video/graphics display device 144, a cursor control device (e.g., a trackpad 150, or gesture or touch screen input), a stylus 148, and/or a keyboard 146, among others. Information handling system 100 may also be operatively coupled to a peripheral device 142 such as a docking station 151 or other smart peripheral device having a hardware processing device such as a hardware processor, microcontroller, or other hardware processing resource and which may further operatively couple to one or more additional peripheral devices 142. As described herein, each of these input/output devices 142 may each be a node device associated with the information handling system 100 and may be part of a peripheral device workspace defined and identified with a peripheral device workspace identification value via execution of the ecosystem manageability service module 168, peripheral device workspace telemetry module 176, cloud orchestrator notification module 180, and cloud manageability orchestrator module 166 as described herein. Various drivers and hardware control device electronics may be operatively coupled to operate the I/O devices 142 according to the embodiments described herein. The present specification contemplates that the I/O devices 142 may be wired or wireless.

A network interface device of the information handling system 100 shown as wireless interface adapter 128 can provide connectivity among devices such as with Bluetooth® or to a network 136, e.g., a wide area network (WAN), a local area network (LAN), wireless local area network (WLAN), a wireless personal area network (WPAN), a wireless wide area network (WWAN), or other network. In an embodiment, this network 136 may be operatively coupled to or include a peripheral device workspace cloud orchestrator 156 that includes one or more servers (e.g., peripheral device workspace cloud orchestrator server 158) or other computing devices that provide computer system resources as described herein that allow for the creation of peripheral device workspaces and orchestration of different node devices within one or more peripheral device workspaces. In embodiments described herein, the wireless interface device 128 with its radio 130, RF front end 132 and antenna 134 is used to communicate with the wireless peripheral devices via, for example, a Bluetooth® or Bluetooth® Low Energy (BLE) protocols. In an embodiment, the WAN, WWAN, LAN, and WLAN may each include an AP 138 or base station 140 used to operatively couple the information handling system 100 to a network 136. In a specific embodiment, the network 136 may include macro-cellular connections via one or more base stations 140 or a wireless AP 138 (e.g., Wi-Fi), or such as through licensed or unlicensed WWAN small cell base stations 140. Connectivity may be via wired or wireless connection. For example, wireless network wireless APs 138 or base stations 140 may be operatively connected to the information handling system 100. Wireless interface adapter 128 may include one or more radio frequency (RF) subsystems (e.g., radio 130) with transmitter/receiver circuitry, modem circuitry, one or more antenna radio frequency (RF) front end circuits 132, one or more wireless controller circuits, amplifiers, antennas 134 and other circuitry of the radio 130 such as one or more antenna ports used for wireless communications via multiple radio access technologies (RATs). The radio 130 may communicate with one or more wireless technology protocols.

In an embodiment, the wireless interface adapter 128 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 128 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes instructions, parameters, and profiles 112 or receives and executes instructions, parameters, and profiles 112 responsive to a propagated signal, so that a hardware device connected to a network 136 may communicate voice, video, or data over the network 136. Further, the instructions 112 may be transmitted or received over the network 136 via the network interface device or wireless interface adapter 128. It is appreciated that any computing device including the cloud orchestrator server 158, the cloud orchestrator console 160 graphical user interface, and the information handling system 100 may include a computer-readable medium that includes instructions, parameters, and profiles 112.

The information handling system 100 may include a set of instructions 112 that may be executed to cause the computer system to perform any one or more of the methods or computer-based functions disclosed herein. For example, instructions 112 may be executed by a hardware processor 102, GPU 103, EC 104 or any other hardware processing resource and may include software agents, or other aspects or components used to execute the methods and systems described herein. Various software modules comprising application instructions 112 may be coordinated by an OS 116, and/or via an application programming interface (API). An example OS 116 may include Windows®, Android®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 112 in which one or more sets of machine-readable code instructions, parameters, and profiles 112 such as firmware or software can be embedded to be executed by the hardware processor 102 or other hardware processing devices such as a GPU 103 or EC 104, or other microcontroller unit to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 103 of information handling system 100.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102 and other hardware components described herein. The PMU 122 may control power to one or more components including the one or more drive units 120, the hardware processor 102 (e.g., CPU), the EC 104, the GPU 103, a video/graphic display device 144, or other wired I/O devices 142 such as the mouse 152, the stylus 148, a keyboard 146, and a trackpad 150 and other components that may require power when a power button has been actuated by a user. In an embodiment, the PMU 122 may monitor power levels and be electrically coupled to the information handling system 100 to provide this power. The PMU 122 may be coupled to the bus 118 to provide or receive data or machine-readable code instructions. The PMU 122 may regulate power from a power source such as the battery 124 or AC power adapter 126. In an embodiment, the battery 124 may be charged via the AC power adapter 126 and provide power to the components of the information handling system 100, via wired connections as applicable, or when AC power from the AC power adapter 126 is removed. It is appreciated that that peripheral device workspace cloud orchestrator server 158 may include a power management unit as well to provide power to the cloud orchestrator hardware processing device 170 and a memory device associated with the peripheral device workspace cloud orchestrator server 158 such as the cloud orchestrator database 184.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 is operatively coupled to a peripheral device workspace cloud orchestrator 156, via a peripheral device server notification gateway 182, that includes any number of servers, computing devices, and other cloud computing resources such as the peripheral device workspace cloud orchestrator server 158. The peripheral device workspace cloud orchestrator 156 may, therefore, include any hardware that may be distributed over multiple physical locations but act in concert with each other and specifically the peripheral device workspace cloud orchestrator server 158 to facilitate the methods and systems described herein. For example, the hardware of the peripheral device workspace cloud orchestrator 156 such as the peripheral device workspace cloud orchestrator server 158 may facilitate an ITDM to, via hardware device operational policies, create a peripheral device workspace with the one or more node devices (e.g., including the information handling system 100 as an anchor node device) forming part of the peripheral device workspace after receiving device enrollment data describing one or more node devices, create hardware device operational policies based on the registered node devices detected within the one or more created peripheral device workspaces, and apply the hardware device operational policies to the created peripheral device workspace. Additionally, according to the principles described herein, the peripheral device workspace cloud orchestrator server 158 may facilitate the generation of unified workspace notifications that the QoE will be affected at one or more device nodes within the workspace based on the QoE values and other data received from an ecosystem manageability sub-agent 172 (e.g., 172-1, 172-2, 172-3) on an anchor information handling system node 100. It is appreciated that the node devices described herein may include each of the peripheral devices operatively coupled to the information handling system 100 acting as a central, main or anchor node device and the workspaces created may be described as a peripheral device workspace.

The peripheral device workspace cloud orchestrator server 158 may be any computing device that may include similar elements as the information handling system 100 such as a memory device, a cloud orchestrator hardware processing device 170, a PMU, and other elements that allow the peripheral device workspace cloud orchestrator server 158 to execute code instructions of the cloud manageability orchestrator module 166, ecosystem manageability service module 168, peripheral device workspace telemetry module 176, cloud orchestrator notification module 180, and other software as described herein.

In an embodiment, the peripheral device workspace cloud orchestrator server 158 may be operatively coupled to a peripheral device workspace cloud orchestrator console 160 graphical user interface. The peripheral device workspace cloud orchestrator console 160 graphical user interface may be used by the ITDM to create and propagate hardware device operational policies, track a lifecycle of ordered node devices, monitor for compliant and non-compliant node devices within a peripheral device workspace, propagate optimal settings for any give node device or types of node devices, monitor and provide recommended software/firmware updates to node devices, remediate software/firmware issues among the plurality of node devices, manage dynamic peripheral device workspace sessions (e.g., associate a user's identification with a peripheral device workspace), enable automatic security updates for node devices within the peripheral device workspace, mange auto-pairing of node devices to other node devices within the peripheral device workspace, and troubleshoot and remediate node deceives from the cloud orchestrator console 160 graphical user interface. It is appreciated that the peripheral device workspace cloud orchestrator console 160 graphical user interface be interfaced with by a cloud orchestrator input device 162 at a cloud orchestrator video display device 164 that allows the ITDM to complete these processes and engage with the peripheral device workspace cloud orchestrator server 158 in an embodiment.

As described herein, the peripheral device workspace cloud orchestrator server 158 includes a computer-readable program code of a peripheral device workspace cloud manageability orchestrator module 166 that, when executed by the cloud orchestrator hardware processing device 170 of the peripheral device workspace cloud orchestrator server 158, receives device enrollment data describing one or more node devices and creates a peripheral device workspace with the one or more node devices forming part of the peripheral device workspace. In the context of the present specification and in the appended claims, a peripheral device workspace may be an ecosystem of node devices (e.g., including peripheral devices coupled to the information handling system 100, a docking station 151, etc.) connected to a central, main, or anchor node device such as the information handling system 100. In an embodiment, a peripheral device workspace may also be defined with a peripheral device workspace identification value and part of a user composite peripheral device workspace identifier associated with each of the information handling system 100 and peripheral devices (e.g., input/output devices 142) such that a user may have multiple peripheral device workspaces having peripheral device workspace identification values associated with the user based on the context and/or environment of each identified peripheral device workspace. For example, a user composite peripheral device workspace identifier may be used to define a first peripheral device workspace at a home office having a first peripheral device workspace identification value, a second peripheral device workspace at a work office having a second peripheral device workspace identification value, a third peripheral device workspace at a different location (e.g., a coffee shop) having a third peripheral device workspace identification value, and other peripheral device workspaces that can be defined by both the node devices included within the peripheral device workspace and the location of the peripheral device workspace (e.g., defined by location data such as GPS data as well as network data) and having a having a peripheral device workspace identification value.

In an embodiment, the execution of computer-readable program code of the peripheral device workspace cloud manageability orchestrator module 166 causes the peripheral device workspace cloud orchestrator server 158 to receive hardware device operational policies based on the registered node devices detected within the one or more created peripheral device workspaces having peripheral device workspace identification values. In an embodiment, the hardware device operational policies are received from the peripheral device workspace cloud orchestrator console 160 graphical user interface as initiated by the ITDM. The ITDM may be any internet technology decision maker that may decide the hardware device operational policies to be associated with peripheral device workspaces formed at the peripheral device workspace cloud orchestrator server 158 and having peripheral device workspace identification values. For example, the ITDM may decide that certain types of node devices are not allowed to be operatively coupled to a central, main, or anchor node device due to potential security issues associated with those types of node devices. In another example, the ITDM may be any internet technology decision maker that may decide which settings for each of the node devices, including the central, main, or anchor node device, is an optimal and desired setting to be used. In an embodiment, the ITDM may create these hardware device operational policies and desired settings at the peripheral device workspace cloud orchestrator console 160 graphical user interface which propagates these hardware device operational policies to the peripheral device workspace cloud orchestrator server 158 executing the peripheral device workspace cloud manageability orchestrator module 166. Upon receipt of these hardware device operational policies created at the peripheral device workspace cloud orchestrator console 160 graphical user interface by the ITDM, the execution of the peripheral device workspace cloud manageability orchestrator module 166 may propagate these hardware device operational policies to each of the device nodes within the created peripheral device workspace thereby eliminating the need for the ITDM to manually address each device node to propagate these hardware device operational policies.

In an embodiment, the peripheral device workspace cloud orchestrator server 158 may also execute computer readable program code of an ecosystem manageability service module 168. Execution of the ecosystem manageability service module 168 applies the hardware device operational policies to the created peripheral device workspace. In an embodiment, the peripheral device workspace cloud manageability orchestrator module 166 creates hardware device operational policies for each of the one or more node devices within the peripheral device workspace based on received hardware device operational policies created by the ITDM. As described herein, the ecosystem manageability service module 168 may identify those peripheral devices that form part of the peripheral device workspace having a peripheral device workspace identifier value and may propagate those hardware device operational policies that apply to those peripheral devices. For example, where a plurality of peripheral device workspaces with a plurality of peripheral device workspace identifier values each include a specific wireless mouse that the ITDM has created a hardware device operational policy for, the execution of the computer-readable program code of the ecosystem manageability service module 168 causes the peripheral device workspace cloud orchestrator server 158 to send those hardware device operational policies to the appropriate peripheral device workspace (e.g., to each of the central, main, or anchor node devices) so that those hardware device operational policies may be passed to the wireless mice in each peripheral device workspace having a peripheral device workspace identifier value where such as specific mouse model or type is located.

As described herein, the peripheral device workspace cloud orchestrator server 158 may, via network interface device, receive quality of experience (QoE) values, user identification data, and node device data associated with a plurality of device nodes within a workspace. This data is used to generate a unified workspace notifications that a QoE will be affected at one or more of the device nodes within the peripheral device workspace. For example, a QoE value may be associated with a hardware resource such as a battery power level of a rechargeable battery, processing availability at a hardware processing device, available data storage in a data storage device, detected thermal levels at hardware devices within each device node, among other QoE values that may affect the QoE associated with any device node within the peripheral device workspace and the peripheral device workspace. In an embodiment, the anchor information handling system node 100 may execute computer-readable program code of an ecosystem manageability sub-agent to implement operating system 116 that requests and receives from each other device node the QoE values associated with a peripheral device workspace. In an embodiment, each node device may include its own ecosystem manageability sub-agent 172-1, 172-2, 172-3 that identifies the QoE values and sends that data to the ecosystem manageability sub-agent 172-1 executing on the anchor information handling system node 100 for the anchor information handling system node 100 to transmit to the QoE values to the peripheral device workspace cloud orchestrator server 158. This transmission of the QoE values may be completed periodically such as every 10 minutes. It is appreciated that that where an anchor information handling system node 100 is not present, the delivery of the QoE values may be completed by a smart device node or other designated device node within the peripheral device workspace that has networking capabilities to be operatively coupled to the peripheral device workspace cloud orchestrator server 158. In an addition to sending the QoE values, the anchor information handling system 100 (or smart device node) may also send user identification data describing the user of the device nodes within the peripheral device workspace. Still further, the anchor information handling system node 100 (or smart node) may send node device data that describes, for example, the make, model, serial number, or other identifier that identifies each of the device nodes within the peripheral device workspace.

When the peripheral device workspace cloud orchestrator server 158 has received the QoE values, the cloud orchestrator hardware processing device 170 executes computer-readable program code of a peripheral device workspace telemetry module to save the QoE values, user identification data, and node device data on a cloud orchestrator database. In an embodiment, this data may be associated with a specific peripheral device workspace and peripheral device workspace identification value so that a manifest of each of the device nodes within the peripheral device workspace may be associated with the data being stored on the cloud orchestrator database 184 by the peripheral device workspace telemetry module 176.

Execution of the peripheral device workspace telemetry module 176 by the cloud orchestrator hardware processing device 170 of the peripheral device workspace cloud orchestrator server 158 also causes the peripheral device workspace cloud orchestrator server 158 to request and receive upcoming user meetings and events associated with the user's use of the plurality of device nodes that are affected by the QoE values. In an embodiment, the peripheral device workspace cloud orchestrator server 158 may request upcoming user meeting data from, for example, the anchor information handling system node 100 that executes a calendaring program such as Microsoft® Outlook®, Google® Calendar, Apple® Calendar, and the like. In an embodiment, the peripheral device workspace cloud orchestrator server 158 may request event data from the anchor information handling system node 100 which may also, in turn, get this event data from each of the device nodes within the peripheral device workspace. In an embodiment, upcoming user meeting data may include data describing upcoming videoconferencing sessions, upcoming business meetings, and other meeting events that the peripheral device workspace is used to engage in the meeting. In an embodiment, event data may include data describing increased use of a device node, execution of processing-intensive applications on the anchor information handling system node 100, smart device nodes, and other peripheral devices within the peripheral device workspace, and/or increases in temperatures of hardware devices of each of the peripheral devices within the peripheral device workspace.

In an embodiment, execution of the peripheral device workspace telemetry module 176 by the cloud orchestrator hardware processing device 170 of the peripheral device workspace cloud orchestrator server 158 may analyze trends regarding the meetings and events received at the peripheral device workspace cloud orchestrator server 158 and provide projections indicative of the QoE values affecting the QoE during the meetings and events. These projections may include, for example, an indication that current battery levels in a rechargeable battery within one of the device nodes within the peripheral device workspace will not last as long as the meeting or event that is taking place. For example, where the peripheral device workspace cloud orchestrator server 158 has received meeting data describing a videoconference meeting the user is to attend, the execution of the peripheral device workspace telemetry module 176 may determine whether the current battery levels in the various device nodes will last the entire videoconference session. For example, the peripheral device workspace telemetry module 176 may review the QoE values as they relate to individual device node battery levels and determine that a docking station 151 is connected to an alternating current (AC) electrical source, the rechargeable battery of a wireless keyboard 146 will last for two hours, an external monitor or video display device 144 is connected to an AC electrical source, a wireless mouse 152 has a determined battery level that will last two hours, and the battery level of a wireless headset 153 will cause the wireless headset 153 to last 15 minutes. Because, in this example embodiment, the videoconferencing session is to last one hour, the execution of the peripheral device workspace telemetry module 176 may indicate that the QoE will drop when the power levels in the rechargeable battery of the wireless headset 153 are depleted. Upon detection of this projected QoE level drop, the execution of the peripheral device workspace telemetry module 176 causes a unified workspace notification to be generated. The unified workspace notifications indicate the QoE will be affected at, in this example embodiment, the wireless headset 153 within the peripheral device workspace and the peripheral device workspace cloud orchestrator server 158 may execute computer-readable program code of a cloud orchestrator notification module 180 that sends those unified workspace notifications to the anchor information handling system node 100 within the peripheral device workspace. The unified workspace notification may indicate to the user of the peripheral device workspace, via a graphical user interface (GUI) presented on the video display device 144, that the QoE will drop when the battery life of the wireless headset 153 is depleted before the videoconferencing session has ended. The user may address this issue and may determine to either switch out the wireless headset 153 for another, fully charged, wireless headset 153, rely on the battery life of the wireless headset 153 until it is depleted and switch to another microphone system during the videoconference session, or simply remove the wireless headset 153 from the peripheral device workspace and rely on an internal microphone in the anchor information handling system node 100 during the videoconferencing session. Either way, the projected change in QoE has been provided to the user to inform the user of the projected change in QoE based on the received meeting and events data and the QoE values thereby, at least, preparing the user for this drop in QoE. Without such a unified workspace notification being generated and presented to the user, the user would otherwise not be aware of the issue until, during the conferencing session, the wireless headset 153 stopped working. By notifying the user prior to this, however, the user may anticipate such a change in QoE and be able to remedy the situation or be prepared for the drop in QoE. It is appreciated that a similar process may be conducted by the peripheral device workspace telemetry module 176 for any meeting or event and for any projected QoE change in any device node within any peripheral device workspace.

After receiving the unified workspace notification from the peripheral device workspace cloud orchestrator server 158, the user may, in an example embodiment, choose to remove a peripheral device that is going to reduce the QoE within the peripheral device workspace. This removal, as indicated herein, may be noted by the cloud manageability orchestrator module 166 when the anchor information handling system node 100 sends data indicating the removal of the device node from the workspace. The anchor information handling system node 100 may do this by executing the ecosystem manageability sub-agent 172-1 to gather current status information from each peripheral device node and sending updates to changes in the composition of the peripheral device workspace. The removal of the device node may be noted in a manifest stored on the cloud orchestrator database 184 by the cloud manageability orchestrator module 166. Because the manifest no longer indicates that the device node is part of the peripheral device workspace, the execution of the peripheral device workspace telemetry module 176 may indicate, via a unified workspace notification that the QoE has been effected due to the removal of the device node. As such, the user may replace the device node with another similar device node (e.g., swap out a battery-depleted wireless headset 153 for a fully charged wireless headset 153). The onboarding of the new device node is also updated in the stored manifest and the peripheral device workspace telemetry module 176 may note this change, request the QoE value for the device node, and again determine whether any unified workspace notification is to be sent to the anchor information handling system node 100.

In an embodiment, the peripheral device workspace cloud orchestrator 156 with the peripheral device workspace cloud orchestrator server 158 may be operatively coupled to a third-party manageability platform 178. A third-party manageability platform 178 may include any endpoint management service such as Microsoft® Intune® that is used to help manage the remote workspaces. The use of the third-party manageability platforms 178 allows an ITDM to help create the peripheral device workspaces, define the peripheral device workspaces, register peripheral devices (e.g., node devices) with the peripheral device workspace cloud orchestrator server 158, modify created peripheral device workspaces each having peripheral device workspace identification values based on detected changes (e.g., inclusion of new node devices, removal of node devices, and swapping of node devices within the workspace, etc.) within any given peripheral device workspace. It is appreciated that any number of third-party manageability platforms 178 operatively coupled to the peripheral device workspace cloud orchestrator server 158 within the peripheral device workspace cloud orchestrator 156 may be used to allow the ITDM to perform these actions as described herein. The peripheral device workspace cloud orchestrator server 158 may, therefore, act as a central location where an ITDM may, via the peripheral device workspace cloud orchestrator console 160 graphical user interface, access data describing each created peripheral device workspace, make changes to the peripheral device workspaces, and submit hardware device operational policies to be applied to any of the node devices within each peripheral device workspace as well as conduct software/firmware updates for all necessary node devices with the execution of the third-party manageability platform 178 within the peripheral device workspace cloud orchestrator 156. In order for the third-party manageability platform 178 to receive data regarding each node device within the peripheral device workspaces, the ecosystem manageability sub-agent 172-1 and a third-party manageability agent 174 may be executed by a hardware processor 102 of the anchor information handling system node 100 acting as the central, main, or anchor node device for a peripheral device workspace. The ecosystem manageability sub-agent 172-1 may gather the node device characteristics at the third-party manageability agent 174 and transmit that data to the third-party manageability platform 178 which shares this data with the peripheral device workspace cloud orchestrator server 158. This data gathered by the third-party manageability agent 174 and sent to the third-party manageability platform 178 may include, at least, identification data that may include a make, model, device ID, serial number, or the like that allows the peripheral device workspace cloud orchestrator server 158 to identify the type, settings, and functions of the device node.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

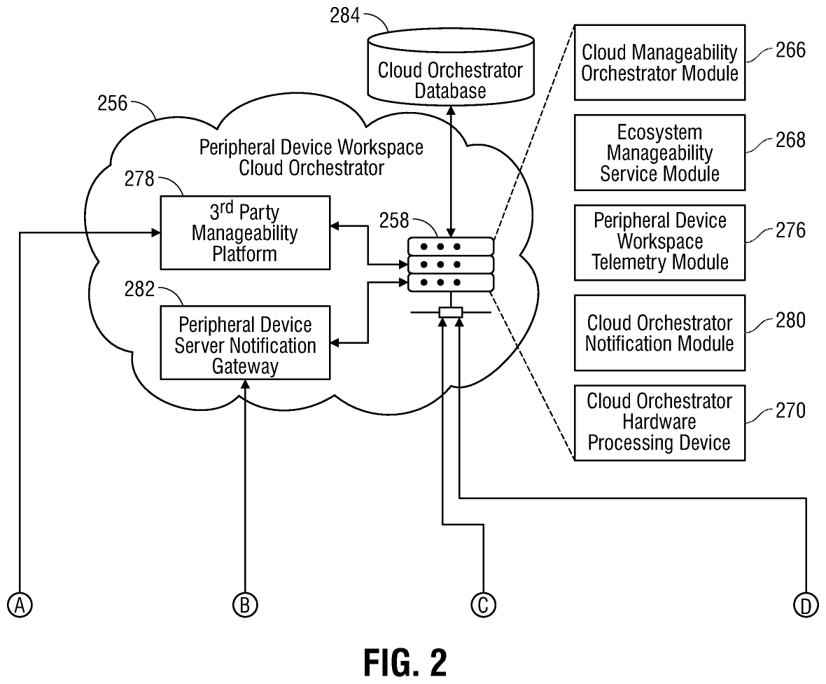

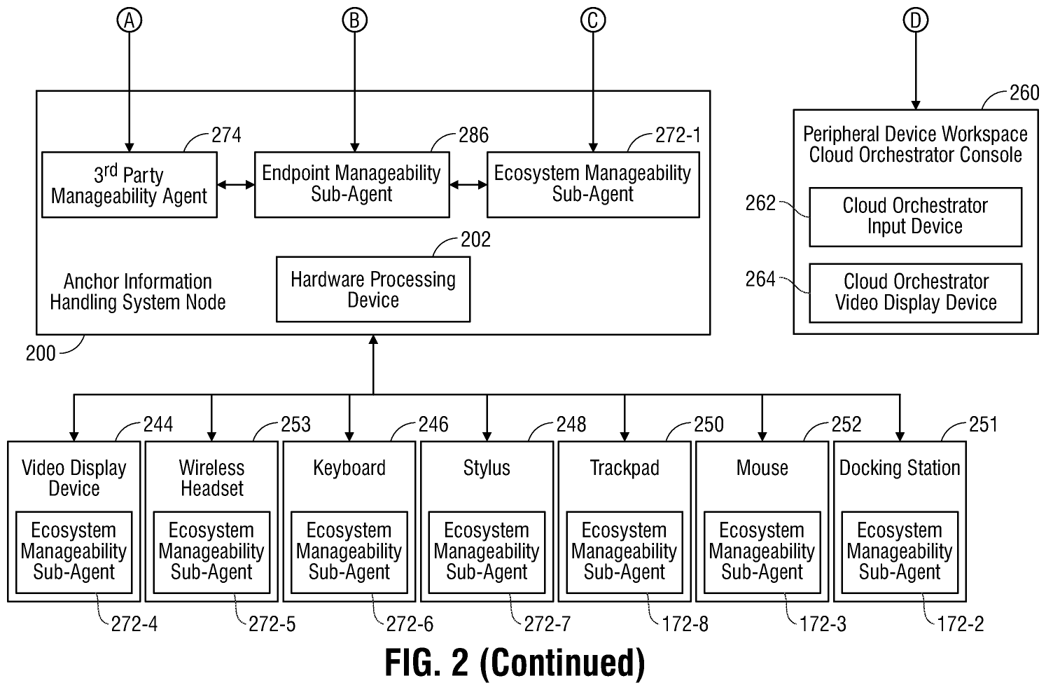

FIG. 2 is a graphic diagram of an anchor information handling system node 200 operatively coupled to a remotely located peripheral device workspace cloud orchestrator server 258 of a peripheral device workspace cloud orchestrator 256 according to an embodiment of the present disclosure. As described herein, the anchor information handling system node 200 may be operatively coupled to the peripheral device workspace cloud orchestrator 256 and its peripheral device workspace cloud orchestrator server 258 via a network interface device that accesses a peripheral device server notification gateway 282 associated with the peripheral device workspace cloud orchestrator server 258.

The peripheral device workspace cloud orchestrator 256 may include any hardware that may be distributed over multiple physical locations but act in concert with each other and specifically the peripheral device workspace cloud orchestrator server 258 to facilitate the methods and systems described herein. For example, the hardware of the peripheral device workspace cloud orchestrator 256 such as the peripheral device workspace cloud orchestrator server 258 may facilitate an ITDM to, via hardware device operational policies, create a peripheral device workspace with the one or more node devices (e.g., including the information handling system 200 as an anchor node device) forming part of the peripheral device workspace after receiving device enrollment data describing one or more node devices, create hardware device operational policies based on the registered node devices detected within the one or more created peripheral device workspaces, and apply the hardware device operational policies to the created peripheral device workspace. Additionally, according to the principles described herein, the peripheral device workspace cloud orchestrator server 258 may facilitate the generation of unified workspace notifications that the QoE will be affected at one or more device nodes within the workspace based on the QoE values and other data received from an ecosystem manageability sub-agent 272 (e.g., 272-1 through 272-8) on an anchor information handling system node 200. It is appreciated that the node devices described herein may include each of the peripheral devices operatively coupled to the information handling system 200 acting as a central, main or anchor node device and the workspaces created may be described as a peripheral device workspace. As shown in FIG. 2, these peripheral device nodes may include a video display device 244 such an external monitor, a wireless headset 253, a keyboard 246 (either wired or wireless), a stylus 246, a trackpad 250, a mouse 252 (either wired or wireless) and a docking station 251 to name a few example peripheral device nodes.

The peripheral device workspace cloud orchestrator server 258 may be any computing device that may include a memory device, a cloud orchestrator hardware processing device 270, a PMU, and other elements that allow the peripheral device workspace cloud orchestrator server 258 to execute code instructions of the cloud manageability orchestrator module 266, ecosystem manageability service module 268, peripheral device workspace telemetry module 276, cloud orchestrator notification module 280, and other software as described herein.

In an embodiment, the peripheral device workspace cloud orchestrator server 258 may be operatively coupled to a peripheral device workspace cloud orchestrator console 260 graphical user interface. The peripheral device workspace cloud orchestrator console 260 graphical user interface may be used by an ITDM to create and propagate hardware device operational policies, track a lifecycle of ordered node devices, monitor for compliant and non-compliant node devices within a peripheral device workspace, propagate optimal settings for any give node device or types of node devices, monitor and provide recommended software/firmware updates to node devices, remediate software/firmware issues among the plurality of node devices, manage dynamic peripheral device workspace sessions (e.g., associate a user's identification with a peripheral device workspace), enable automatic security updates for node devices within the peripheral device workspace, mange auto-pairing of node devices to other node devices within the peripheral device workspace, and troubleshoot and remediate node deceives from the cloud orchestrator console 260 graphical user interface. It is appreciated that the peripheral device workspace cloud orchestrator console 260 may include a cloud orchestrator input device 262 and a cloud orchestrator video display device 264 that allows the ITDM to complete these processes and engage with the peripheral device workspace cloud orchestrator server 258 in an embodiment.

As described herein, the peripheral device workspace cloud orchestrator server 258 includes a computer-readable program code of a peripheral device workspace cloud manageability orchestrator module 266 that, when executed by the cloud orchestrator hardware processing device 270 of the peripheral device workspace cloud orchestrator server 258, receives device enrollment data describing one or more node devices and creates a peripheral device workspace with the one or more node devices forming part of the peripheral device workspace. In the context of the present specification and in the appended claims, a peripheral device workspace may be an ecosystem of node devices (e.g., including peripheral devices coupled to the information handling system 200, a docking station 251, etc.) connected to a central, main, or anchor node device such as the information handling system 200. In an embodiment, a peripheral device workspace may also be defined with a peripheral device workspace identification value and part of a user composite peripheral device workspace identifier associated with each of the information handling system 200 and peripheral devices (e.g., input/output devices 242) such that a user may have multiple peripheral device workspaces having peripheral device workspace identification values associated with the user based on the context and/or environment of each identified peripheral device workspace. For example, a user composite peripheral device workspace identifier may be used to define a first peripheral device workspace at a home office having a first peripheral device workspace identification value, a second peripheral device workspace at a work office having a second peripheral device workspace identification value, a third peripheral device workspace at a different location (e.g., a coffee shop) having a third peripheral device workspace identification value, and other peripheral device workspaces that can be defined by both the node devices included within the peripheral device workspace and the location of the peripheral device workspace (e.g., defined by location data such as GPS data as well as network data) and having a having a peripheral device workspace identification value.

In an embodiment, the execution of computer-readable program code of the peripheral device workspace cloud manageability orchestrator module 266 causes the peripheral device workspace cloud orchestrator server 258 to receive hardware device operational policies based on the registered node devices detected within the one or more created peripheral device workspaces having peripheral device workspace identification values. In an embodiment, the hardware device operational policies are received from the peripheral device workspace cloud orchestrator console 260 graphical user interface as initiated by the ITDM. The ITDM may be any internet technology decision maker that may decide the hardware device operational policies to be associated with peripheral device workspaces formed at the peripheral device workspace cloud orchestrator server 258 and having peripheral device workspace identification values. For example, the ITDM may decide that certain types of node devices are not allowed to be operatively coupled to a central, main, or anchor node device due to potential security issues associated with those types of node devices. In another example, the ITDM may be any internet technology decision maker that may decide which settings for each of the node devices, including the central, main, or anchor node device, is an optimal and desired setting to be used. In an embodiment, the ITDM may create these hardware device operational policies and desired settings at the peripheral device workspace cloud orchestrator console 260 graphical user interface which propagates these hardware device operational policies to the peripheral device workspace cloud orchestrator server 258 executing the peripheral device workspace cloud manageability orchestrator module 266. Upon receipt of these hardware device operational policies created at the peripheral device workspace cloud orchestrator console 260 graphical user interface by the ITDM, the execution of the peripheral device workspace cloud manageability orchestrator module 266 may propagate these hardware device operational policies to each of the device nodes within the created peripheral device workspace thereby eliminating the need for the ITDM to manually address each device node to propagate these hardware device operational policies.

In an embodiment, the peripheral device workspace cloud orchestrator server 258 may also execute computer readable program code of an ecosystem manageability service module 268. Execution of the ecosystem manageability service module 268 applies the hardware device operational policies to the created peripheral device workspace. In an embodiment, the peripheral device workspace cloud manageability orchestrator module 266 creates hardware device operational policies for each of the one or more node devices within the peripheral device workspace based on received hardware device operational policies created by the ITDM. As described herein, the ecosystem manageability service module 268 may identify those peripheral devices that form part of the peripheral device workspace having a peripheral device workspace identifier value and may propagate those hardware device operational policies that apply to those peripheral devices. For example, where a plurality of peripheral device workspaces with a plurality of peripheral device workspace identifier values each include a specific wireless mouse that the ITDM has created a hardware device operational policy for, the execution of the computer-readable program code of the ecosystem manageability service module 268 causes the peripheral device workspace cloud orchestrator server 258 to send those hardware device operational policies to the appropriate peripheral device workspace (e.g., to each of the central, main, or anchor node devices) so that those hardware device operational policies may be passed to the wireless mice in each peripheral device workspace having a peripheral device workspace identifier value where such as specific mouse model or type is located.

As described herein, the peripheral device workspace cloud orchestrator server 258 may, via network interface device, receive quality of experience (QoE) values, user identification data, and node device data associated with a plurality of device nodes within a workspace. This data is used to generate a unified workspace notifications that a QoE will be affected at one or more of the device nodes within the peripheral device workspace. For example, a QoE value may be associated with a hardware resource such as a battery power level of a rechargeable battery, processing availability at a hardware processing device, a processing resource threshold value, available data storage in a data storage device, detected thermal levels at hardware devices within each device node, among other QoE values that may affect the QoE associated with any device node within the peripheral device workspace and the peripheral device workspace. In an embodiment, the anchor information handling system node 200 may execute computer-readable program code of an ecosystem manageability sub-agent to implement an operating system that requests and receives from each other device node within the peripheral device workspace. In an embodiment, each node device may include its own ecosystem manageability sub-agent 272-1 through 272-9 that identifies the QoE values and sends that data to the ecosystem manageability sub-agent 272-1 executing on the anchor information handling system node 200 for the anchor information handling system node 200 to transmit to the QoE values to the peripheral device workspace cloud orchestrator server 258. This transmission of the QoE values may be completed periodically such as every 10 minutes. It is appreciated that that where an anchor information handling system node 200 is not present, the delivery of the QoE values may be completed by a smart device node or other designated device node within the peripheral device workspace that has networking capabilities to be operatively coupled to the peripheral device workspace cloud orchestrator server 258. In an addition to sending the QoE values, the anchor information handling system 200 (or smart device node) may also send user identification data describing the user of the device nodes within the peripheral device workspace. Still further, the anchor information handling system node 200 (or smart node) may send node device data that describes, for example, the make, model, serial number, or other identifier that identifies each of the device nodes within the peripheral device workspace.

When the peripheral device workspace cloud orchestrator server 258 has received the QoE values, the cloud orchestrator hardware processing device 270 executes computer-readable program code of a peripheral device workspace telemetry module to save the QoE values, user identification data, and node device data on a cloud orchestrator database. In an embodiment, this data may be associated with a specific peripheral device workspace and peripheral device workspace identification value so that a manifest of each of the device nodes within the peripheral device workspace may be associated with the data being stored on the cloud orchestrator database 284 by the peripheral device workspace telemetry module 276.

Execution of the peripheral device workspace telemetry module 276 by the cloud orchestrator hardware processing device 270 of the peripheral device workspace cloud orchestrator server 258 also causes the peripheral device workspace cloud orchestrator server 258 to request and receive upcoming user meetings and events associated with the user's use of the plurality of device nodes that are affected by the QoE values. In an embodiment, the peripheral device workspace cloud orchestrator server 258 may request upcoming user meeting data from, for example, the anchor information handling system node 200 that executes a calendaring program such as Microsoft® Outlook®, Google® Calendar, Apple® Calendar, and the like. In an embodiment, the peripheral device workspace cloud orchestrator server 258 may request event data from the anchor information handling system node 200 which may also, in turn, get this event data from each of the device nodes within the peripheral device workspace. In an embodiment, upcoming user meeting data may include data describing upcoming videoconferencing sessions, upcoming business meetings, and other meeting events that the peripheral device workspace is used to engage in the meeting. In an embodiment, event data may include data describing increased use of a device node, execution of processing-intensive applications on the anchor information handling system node 200, smart device nodes, and other peripheral devices within the peripheral device workspace, and/or increases in temperatures of hardware devices of each of the peripheral devices within the peripheral device workspace.

In an embodiment, execution of the peripheral device workspace telemetry module 276 by the cloud orchestrator hardware processing device 270 of the peripheral device workspace cloud orchestrator server 258 may analyze trends regarding the meetings and events received at the peripheral device workspace cloud orchestrator server 258 and provide projections indicative of the QoE values affecting the QoE during the meetings and events. These projections may include, for example, an indication that current processing resources are meeting or exceeding a processing resource threshold within one of the device nodes within the peripheral device workspace. In an embodiment, the processing resource threshold may be set to any threshold level including a 100% processing resource limit at a hardware processing device within any of the device nodes within the peripheral device workspace. For example, the peripheral device workspace cloud orchestrator server 258 may receive event data that indicates that the anchor information handling system node 200 has executed a gaming application that, due to historic event data, has previously caused the hardware processing device to meet or exceed the processing resource threshold. In this example, the peripheral device workspace telemetry module 276 may review the QoE values as they relate to individual device node hardware processing resource levels and determine that a docking station 251 includes a hardware processing device and the wireless keyboard 246, wireless mouse 252, wireless headset 253, trackpad 250, and stylus 248 have microcontrollers only. Because, in this example embodiment, the increase in consumed processing resources at the anchor information handling system node 200 due to the execution of the gaming application is increased up and past a processing resource threshold, the QoE may drop. Upon detection of this projected QoE level drop, the execution of the peripheral device workspace telemetry module 276 causes a unified workspace notification to be generated. The unified workspace notifications indicate the QoE will be affected at, in this example embodiment, the anchor information handling system node 200 within the peripheral device workspace. As such, the peripheral device workspace cloud orchestrator server 258 may execute computer-readable program code of a cloud orchestrator notification module 280 that sends those unified workspace notifications to the anchor information handling system node 200 within the peripheral device workspace. The unified workspace notification may indicate to the user of the peripheral device workspace, via a GUI presented on the video display device 244, that the QoE will drop as a result of the execution of the gaming application such that the user is warned about this drop prior to, for example, the hardware processing device 202 overheats. The user may address this issue and may determine to remedy the situation by reducing other processes currently being executed on the anchor information handling system node 200. In this example embodiment, the projected change in QoE has been provided to the user in order to inform the user of the projected change in QoE based on the received meeting and events data and the QoE values thereby, at least, preparing the user for this drop in QoE. Without such a unified workspace notification being generated and presented to the user, the user would otherwise not be aware of the issue until the hardware processing device 202 has overheated. By notifying the user prior to this, however, the user may anticipate such a change in QoE and be able to remedy the situation or be prepared for the drop in QoE. It is appreciated that a similar process may be conducted by the peripheral device workspace telemetry module 276 for any meeting or event and for any projected QoE change in any device node within any peripheral device workspace.

Again, after receiving the unified workspace notification from the peripheral device workspace cloud orchestrator server 258, the user may, in an example embodiment, choose to remove a peripheral device that is going to reduce the QoE within the peripheral device workspace. This removal, as indicated herein, may be noted by the cloud manageability orchestrator module 266 when the anchor information handling system node 200 sends data indicating the removal of the device node from the workspace. The anchor information handling system node 200 may do this by executing the ecosystem manageability sub-agent 272-1 in order to gather current status information from each peripheral device node and sending updates to changes in the composition of the peripheral device workspace. The removal of the device node may be noted in a manifest stored on the cloud orchestrator database 284 by the cloud manageability orchestrator module 266. Because the manifest no longer indicates that the device node is part of the peripheral device workspace, the execution of the peripheral device workspace telemetry module 276 may indicate, via a unified workspace notification that the QoE has been effected due to the removal of the device node. As such, the user may replace the device node with another similar device node (e.g., swap out a battery-depleted wireless headset 253 for a fully charged wireless headset 253). The onboarding of the new device node is also updated in the stored manifest and the peripheral device workspace telemetry module 276 may note this change, request the QoE value for the device node, and again determine whether any unified workspace notification is to be sent to the anchor information handling system node 200.

In an embodiment, the peripheral device workspace cloud orchestrator 256 with the peripheral device workspace cloud orchestrator server 258 may be operatively coupled to a third-party manageability platform 278. A third-party manageability platform 278 may include any endpoint management service such as Microsoft® Intune® that is used to help manage the remote workspaces. The use of the third-party manageability platforms 278 allows an ITDM to help create the peripheral device workspaces, define the peripheral device workspaces, register peripheral devices (e.g., node devices) with the peripheral device workspace cloud orchestrator server 258, modify created peripheral device workspaces each having peripheral device workspace identification values based on detected changes (e.g., inclusion of new node devices, removal of node devices, and swapping of node devices within the workspace, etc.) within any given peripheral device workspace. It is appreciated that any number of third-party manageability platforms 278 operatively coupled to the peripheral device workspace cloud orchestrator server 258 within the peripheral device workspace cloud orchestrator 256 may be used to allow the ITDM to perform these actions as described herein. The peripheral device workspace cloud orchestrator server 258 may, therefore, act as a central location where an ITDM may, via the peripheral device workspace cloud orchestrator console 260 graphical user interface, access data describing each created peripheral device workspace, make changes to the peripheral device workspaces, and submit hardware device operational policies to be applied to any of the node devices within each peripheral device workspace as well as conduct software/firmware updates for all necessary node devices with the execution of the third-party manageability platform 278 within the peripheral device workspace cloud orchestrator 256. In order for the third-party manageability platform 278 to receive data regarding each node device within the peripheral device workspaces, the ecosystem manageability sub-agent 272-1 and a third-party manageability agent 274 may be executed by a hardware processor 202 of the anchor information handling system node 200 acting as the central, main, or anchor node device for a peripheral device workspace. The ecosystem manageability sub-agent 272-1 may gather the node device characteristics at the third-party manageability agent 274 and transmit that data to the third-party manageability platform 278 which shares this data with the peripheral device workspace cloud orchestrator server 258. This data gathered by the third-party manageability agent 274 and sent to the third-party manageability platform 278 may include, at least, identification data that may include a make, model, device ID, serial number, or the like that allows the peripheral device workspace cloud orchestrator server 258 to identify the type, settings, and functions of the device node.

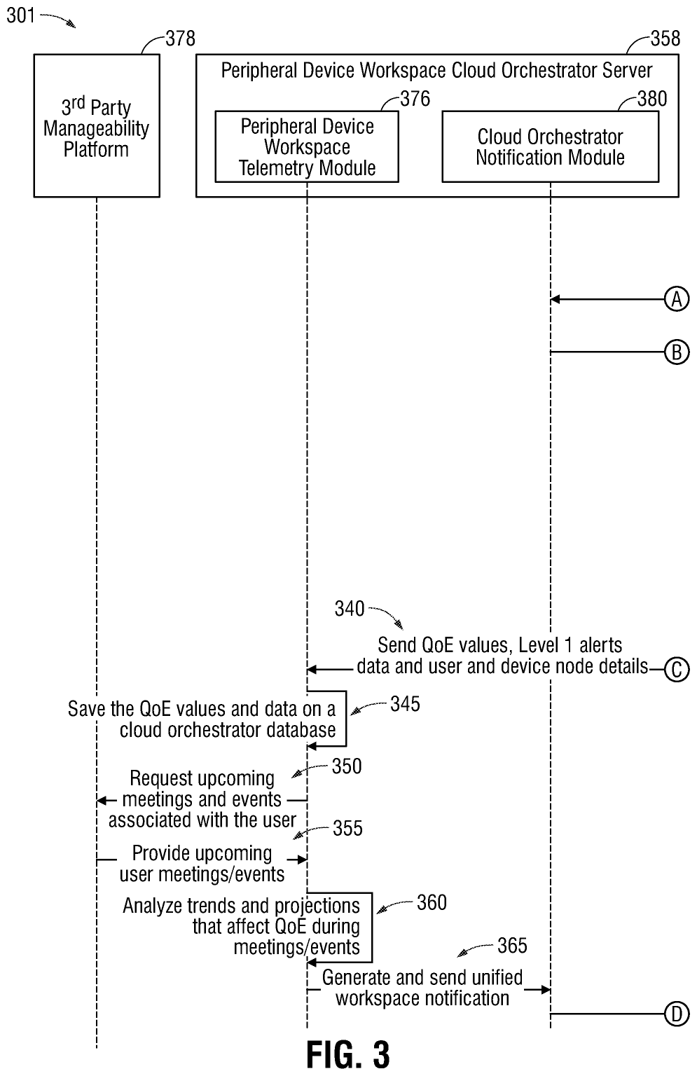

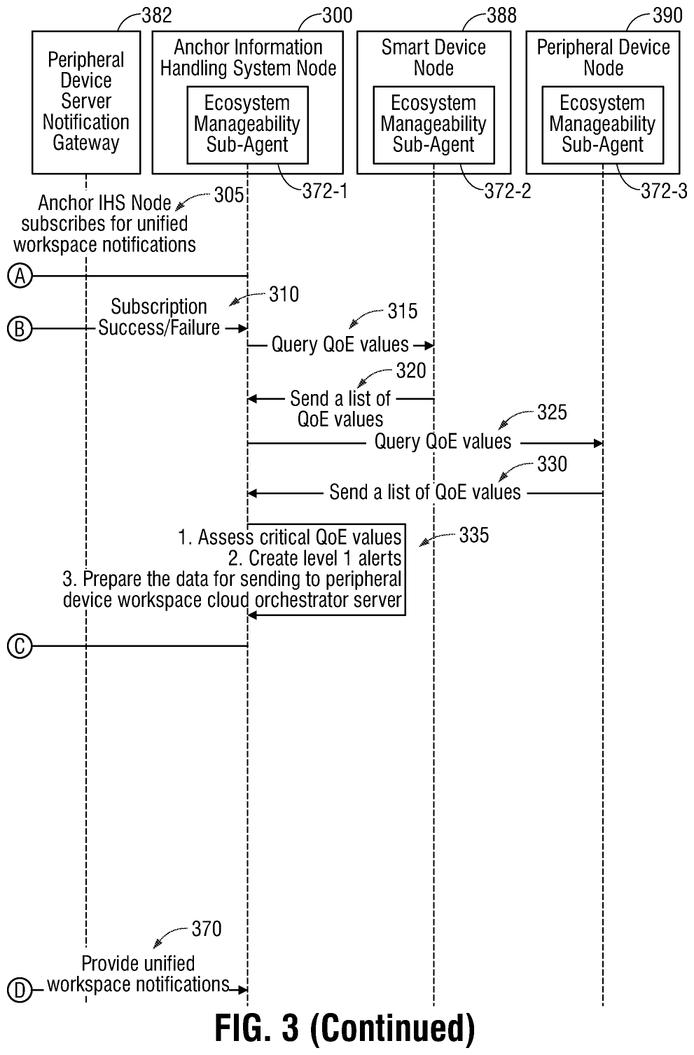

FIG. 3 is a flow chart showing a method 301 of providing or unified workspace notifications to a device node within a peripheral device workspace according to an embodiment of the present disclosure. As described herein, the unified workspace notifications may be used to inform the user within the peripheral device workspace of potential QoE issues that is or will arise based on received QoE values and meetings and events data as described herein.

The method 301 may include, at line 305, with the anchor information handling system node 300 subscribing for unified workspace notifications. In an embodiment, the anchor information handling system node 300 may communicate this request to a cloud orchestrator notification module 380 of a peripheral device workspace orchestrator server 358. In an embodiment, the cloud orchestrator notification module 380 may be provided, by the ecosystem manageability sub-agent 372-1 of the anchor information handling system node 300, with an identification of the user, a device ID associated with the anchor information handling system node 300, and other information such as payment information so that the cloud orchestrator notification module 380 may register the anchor information handling system node 300 to receive unified workspace notifications.

At line 310, the method 301 includes the cloud orchestrator notification module 380 processing the request at line 305 and informing the anchor information handling system node 300 whether the subscription has failed or succeeded. Where the subscription has failed, the method 301 may end. Where the subscription has succeeded, the method 301 may proceed to line 315.

At lines 315 and 325, the ecosystem manageability sub-agent 372-1 may communicate with the individual ecosystem manageability sub-agents 372-2, 372-3 of a smart device node 388 and other peripheral device nodes 390 within the peripheral device workspace in order to request and receive QoE values. Although FIG. 3 shows a single smart device node 388 and a single peripheral device node 390, the present specification contemplates that additional smart nodes and peripheral device nodes (either wired or wireless) may be included within the peripheral device workspace. As described herein, the QoE values may be any value associated with a hardware device in any of the anchor information handling system node 300, smart device node 388, and/or peripheral device node 390 that may affect the quality of experience associated with the anchor information handling system node 300, the smart device nodes 388, and peripheral device nodes 390. For example, a QoE value may be associated with a hardware resource such as a battery power level of a rechargeable battery, processing availability at a hardware processing device, available data storage in a data storage device, detected thermal levels at hardware devices within each device node, among other QoE values.

At lines 320 and 330, each of the smart device nodes 388 and peripheral device nodes 390 may send a list of QoE values. In an embodiment, these QoE values may be in the form of current QoE values at each of these device nodes. It is appreciated that the processes described in connection with lines 315, 320, 325, and 330 may be repeated any number of times at predetermined intervals in order to provide the anchor information handling system node 300 with the most up to date QoE values during the operation of these device nodes (e.g., anchor information handling system node 300, smart device node 388, peripheral device node 390).

At line 335, the hardware processing device of the anchor information handling system node 300 executes the computer-readable program code of the ecosystem manageability sub-agent 372-1 to, initially, assess whether the QoE values received from the device nodes and present at the anchor information handling system node 300 are critical QoE values. In an embodiment, although the criticality of some of these QoE values are being determined at the anchor information handling system node 300, it is also appreciated that such analysis can be made at, for example, the peripheral device workspace telemetry module 376 at the peripheral device workspace orchestrator server 358 with the list of QoE values being sent directly from the anchor information handling system node 300 to the peripheral device workspace orchestrator server 358 via a network connection.

At line 335, the execution of the computer-readable program code of the ecosystem manageability sub-agent 372-1 may also create level 1 alerts. For example, level 1 alerts may include critical alerts that need immediate attention such as processing resources being exceeded, battery levels in a rechargeable battery being depleted, and data storage capacity being reached. It is also appreciated that other levels of alerts such as level 2 alerts may be created that are informational alerts such as projected resource capacities soon to be reached due to trend projections. At line 335, the data associated with the QoE values and level 1 and 2 alerts may be prepared for transmission to the peripheral device workspace orchestrator server 358.

At line 340, the QoE values and level 1 alerts data may be sent to the peripheral device workspace telemetry module 376 of the peripheral device workspace orchestrator server 358. Additionally, at line 340, user and device node details may also be sent. In an embodiment, the user may be identified using, for example, a user ID, an email address, and/or some other user identification value that the peripheral device workspace orchestrator server 358 may use to identify the user. Additionally, the device node details may include data that describes the make, model, serial number, or other identifier that identifies each of the device nodes within the peripheral device workspace that includes, in the present example, the anchor information handling system node 300, the smart device node 388, and the peripheral device node 390.

At line 345, the cloud orchestrator hardware processing device of the peripheral device workspace orchestrator server 358 executes computer-readable program code of the peripheral device workspace telemetry module 376 to save the QoE values, user identification data, and node device data on a cloud orchestrator database. In an embodiment, this data may be associated with a specific peripheral device workspace and peripheral device workspace identification value so that a manifest of each of the device nodes within the peripheral device workspace may be associated with the data being stored on the cloud orchestrator database by the peripheral device workspace telemetry module 376.

At line 350, the execution of the computer-readable program code of the peripheral device workspace telemetry module 376, causes the peripheral device workspace orchestrator server 358 to request for upcoming meetings and events associated with the user. As described herein, the peripheral device workspace cloud orchestrator server 358 may request upcoming user meeting data from, for example, the anchor information handling system node 300 that executes a calendaring program such as Microsoft® Outlook®, Google® Calendar, Apple® Calendar, and the like. This meeting data may be provided to the third-party manageability platform 378 via execution of a third-party manageability agent by a hardware processing device of the anchor information handling system node 300. In an embodiment, the peripheral device workspace cloud orchestrator server 358 may request event data from the anchor information handling system node 300 which may also, in turn, get this event data from each of the device nodes within the peripheral device workspace. Again, this event data may be provided to the third-party manageability platform 378 via execution of a third-party manageability agent by a hardware processing device of the anchor information handling system node 300. At line 355, the third-party manageability platform 378 may provide this meeting and event data to the peripheral device workspace orchestrator server 358 for the peripheral device workspace telemetry module 376 to use as described herein.

At line 360, the execution of the peripheral device workspace telemetry module 376 causes the peripheral device workspace orchestrator server 358 to analyze trends and projections that affect the QoE during the meetings and events based on the received QoE values received and the meetings and events data received at the peripheral device workspace orchestrator server 358.

In an example, the peripheral device workspace telemetry module 376 may review the QoE values as they relate to individual device node battery levels and determine that a docking station is connected to an AC electrical source, the rechargeable battery of a wireless keyboard will last for two hours, an external monitor or video display device is connected to an AC electrical source, a wireless mouse has a determined battery level that will last two hours, and the battery level of a wireless headset will cause the wireless headset to last 15 minutes. Because, in this example embodiment, the videoconferencing session is to last one hour, the execution of the peripheral device workspace telemetry module 376 may indicate that the QoE will drop when the power levels in the rechargeable battery of the wireless headset are depleted. Upon detection of this projected QoE level drop, the execution of the peripheral device workspace telemetry module 376 causes a unified workspace notification to be generated at line 365 and sent to the cloud orchestrator notification module 380. The unified workspace notifications indicate the QoE will be affected at, in this example embodiment, the wireless headset within the peripheral device workspace and the peripheral device workspace cloud orchestrator server 358 may execute computer-readable program code of the cloud orchestrator notification module 380 that sends those unified workspace notifications to the anchor information handling system node 300 within the peripheral device workspace at line 365.

The unified workspace notification may be sent, at line 370, from the cloud orchestrator notification module 380 to the anchor information handling system node 300. The unified workspace notification may indicate to the user of the peripheral device workspace, via a GUI presented on the video display device, that the QoE will drop when the battery life of the wireless headset is depleted before the videoconferencing session has ended. The user may address this issue and may determine to either switch out the wireless headset for another, fully charged, wireless headset, rely on the battery life of the wireless headset until it is depleted and switch to another microphone system during the videoconference session, or simply remove the wireless headset from the peripheral device workspace and rely on an internal microphone in the anchor information handling system node 300 during the videoconferencing session. Either way, the projected change in QoE has been provided to the user in order to inform the user of the projected change in QoE based on the received meeting and events data and the QoE values thereby, at least, preparing the user for this drop in QoE. Without such a unified workspace notification being generated and presented to the user, the user would otherwise not be aware of the issue until, during the conferencing session, the wireless headset stopped working. By notifying the user prior to this, however, the user may anticipate such a change in QoE and be able to remedy the situation or be prepared for the drop in QoE. It is appreciated that a similar process may be conducted by the peripheral device workspace telemetry module 376 for any meeting or event and for any projected QoE change in any device node within any peripheral device workspace.

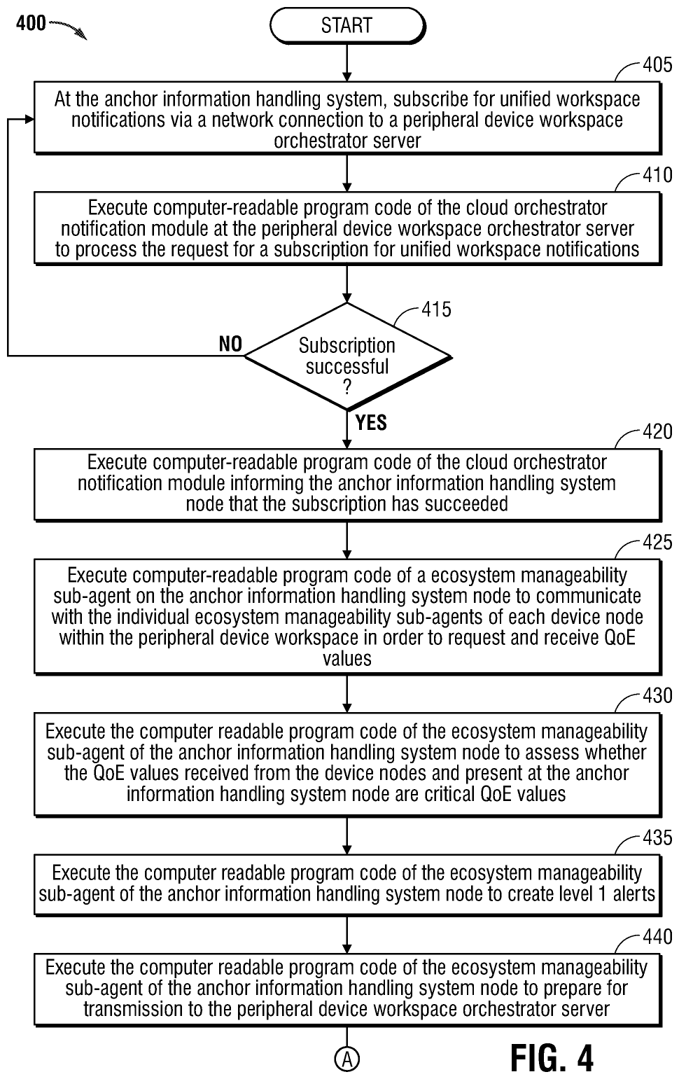

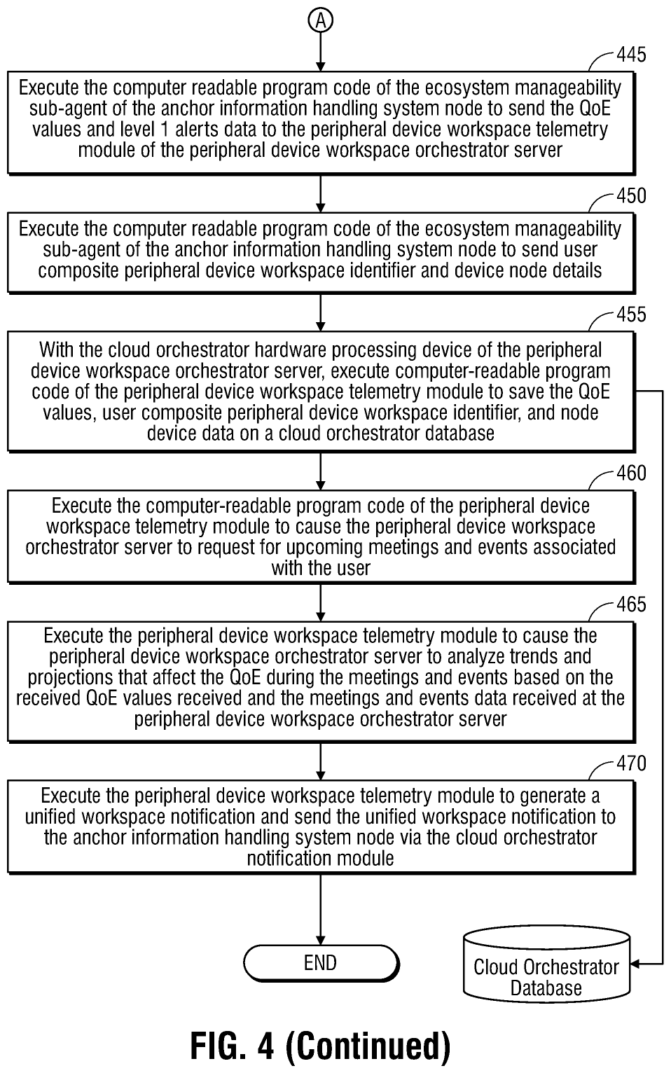

FIG. 4 is a flow chart showing a method 400 of providing unified workspace level alerts to a device node within a peripheral device workspace according to an embodiment of the present disclosure. Again, the unified workspace notifications may be used to inform the user within the peripheral device workspace of potential QoE issues that is or will arise based on received QoE values and meetings and events data as described herein.

The method 400 may include, at block 405, with the anchor information handling system node 300 subscribing for unified workspace notifications. In an embodiment, the anchor information handling system node may communicate this request to a cloud orchestrator notification module of a peripheral device workspace orchestrator server. In an embodiment, the cloud orchestrator notification module may be provided, by the ecosystem manageability sub-agent of the anchor information handling system node, with an identification of the user, a device ID associated with the anchor information handling system node, and other information such as payment information so that the cloud orchestrator notification module may register the anchor information handling system node to receive unified workspace notifications.

At block 410, the method 400 includes executing computer-readable program code of the cloud orchestrator notification module at the peripheral device workspace orchestrator server to process the request for a subscription for unified workspace notifications. At block 415, the anchor information handling system node may determine whether the subscription process was a success or not. Where the subscription process failed, the method 400 returns to block 405 for the user to try again. Where the subscription process is a success, the method 400 continues to block 420 with the cloud orchestrator notification module informing the anchor information handling system node that the subscription has succeeded.

At block 425, the ecosystem manageability sub-agent 372-1 may communicate with the individual ecosystem manageability sub-agents of each device nodes within the peripheral device workspace in order to request and receive QoE values. As described herein, the QoE values may be any value associated with a hardware device in any of the anchor information handling system node, smart device node, and/or peripheral device node that may affect the quality of experience associated with the anchor information handling system node, the smart device nodes, and peripheral device nodes. For example, a QoE value may be associated with a hardware resource such as a battery power level of a rechargeable battery, processing availability at a hardware processing device, available data storage in a data storage device, detected thermal levels at hardware devices within each device node, among other QoE values.

At block 430, each of the device nodes may send a list of QoE values. In an embodiment, these QoE values may be in the form of current QoE values at each of these device nodes. It is appreciated that the processes described in connection with block 430 may be repeated any number of times at predetermined intervals in order to provide the anchor information handling system node with the most up to date QoE values during the operation of these device nodes (e.g., anchor information handling system node, smart device node, peripheral device node).

At block 435, the hardware processing device of the anchor information handling system node executes the computer-readable program code of the ecosystem manageability sub-agent to, initially, assess whether the QoE values received from the device nodes and present at the anchor information handling system node are critical QoE values. In an embodiment, although the criticality of some of these QoE values are being determined at the anchor information handling system node, it is also appreciated that such analysis can be made at, for example, the peripheral device workspace telemetry module at the peripheral device workspace orchestrator server with the list of QoE values being sent directly from the anchor information handling system node to the peripheral device workspace orchestrator server via a network connection.

At block 435, the execution of the computer-readable program code of the ecosystem manageability sub-agent may also create level 1 alerts. For example, level 1 alerts may include critical alerts that need immediate attention such as processing resources being exceeded, battery levels in a rechargeable battery being depleted, and data storage capacity being reached. It is also appreciated that other levels of alerts such as level 2 alerts may be created that are informational alerts such as projected resource capacities soon to be reached due to trend projections. At block 440, the data associated with the QoE values and level 1 and 2 alerts may be prepared for transmission to the peripheral device workspace orchestrator server.

At block 445, the QoE values and level 1 alerts data may be sent to the peripheral device workspace telemetry module of the peripheral device workspace orchestrator server. As described herein, a network interface device at the anchor information handling system node 300 may be used to communicate this data, over a network, to the peripheral device workspace orchestrator server 358.

Additionally, at block 445, user and device node details may also be sent. In an embodiment, the user may be identified using, for example, a user composite peripheral device workspace identifier, an email address, and/or some other user identification value that the peripheral device workspace orchestrator server may use to identify the user. Additionally, the device node details may include data that describes the make, model, serial number, or other identifier that identifies each of the device nodes within the peripheral device workspace that includes, in the present example, the anchor information handling system node, the smart device node, and the peripheral device node.

At block 455, the cloud orchestrator hardware processing device of the peripheral device workspace orchestrator server executes computer-readable program code of the peripheral device workspace telemetry module to save the QoE values, user identification data, and node device data on a cloud orchestrator database. In an embodiment, this data may be associated with a specific peripheral device workspace and peripheral device workspace identification value so that a manifest of each of the device nodes within the peripheral device workspace may be associated with the data being stored on the cloud orchestrator database by the peripheral device workspace telemetry module.

At block 460, the execution of the computer-readable program code of the peripheral device workspace telemetry module causes the peripheral device workspace orchestrator server to request for upcoming meetings and events associated with the user. As described herein, the peripheral device workspace cloud orchestrator server may request upcoming user meeting data from, for example, the anchor information handling system node that executes a calendaring program such as Microsoft® Outlook®, Google® Calendar, Apple® Calendar, and the like. This meeting data may be provided to the third-party manageability platform via execution of a third-party manageability agent by a hardware processing device of the anchor information handling system node. In an embodiment, the peripheral device workspace cloud orchestrator server may request event data from the anchor information handling system node which may also, in turn, get this event data from each of the device nodes within the peripheral device workspace. Again, this event data may be provided to the third-party manageability platform via execution of a third-party manageability agent by a hardware processing device of the anchor information handling system node. The third-party manageability platform may provide this meeting and event data to the peripheral device workspace orchestrator server for the peripheral device workspace telemetry module to use as described herein.

At block 465, the execution of the peripheral device workspace telemetry module causes the peripheral device workspace orchestrator server to analyze trends and projections that affect the QoE during the meetings and events based on the received QoE values received and the meetings and events data received at the peripheral device workspace orchestrator server. In an example, the peripheral device workspace telemetry module may review the QoE values as they relate to individual device node battery levels and determine that a docking station is connected to an AC electrical source, the rechargeable battery of a wireless keyboard will last for two hours, an external monitor or video display device is connected to an AC electrical source, a wireless mouse has a determined battery level that will last two hours, and the battery level of a wireless headset will cause the wireless headset to last 15 minutes. Because, in this example embodiment, the videoconferencing session is to last one hour, the execution of the peripheral device workspace telemetry module may indicate that the QoE will drop when the power levels in the rechargeable battery of the wireless headset are depleted.

Upon detection of this projected QoE level drop, the execution of the peripheral device workspace telemetry module causes a unified workspace notification to be generated, at block 470, and sent to the anchor information handling system node via the cloud orchestrator notification module. The unified workspace notifications indicate the QoE will be affected at, in this example embodiment, the wireless headset within the peripheral device workspace and the peripheral device workspace cloud orchestrator server may execute computer-readable program code of the cloud orchestrator notification module that sends those unified workspace notifications to the anchor information handling system node within the peripheral device workspace at line.

The unified workspace notification may be sent from the cloud orchestrator notification module to the anchor information handling system node. The unified workspace notification may indicate to the user of the peripheral device workspace, via a GUI presented on the video display device, that the QoE will drop when the battery life of the wireless headset is depleted before the videoconferencing session has ended. The user may address this issue and may determine to either switch out the wireless headset for another, fully charged, wireless headset, rely on the battery life of the wireless headset until it is depleted and switch to another microphone system during the videoconference session, or simply remove the wireless headset from the peripheral device workspace and rely on an internal microphone in the anchor information handling system node during the videoconferencing session. Either way, the projected change in QoE has been provided to the user in order to inform the user of the projected change in QoE based on the received meeting and events data and the QoE values thereby, at least, preparing the user for this drop in QoE. Without such a unified workspace notification being generated and presented to the user, the user would otherwise not be aware of the issue until, during the conferencing session, the wireless headset stopped working. By notifying the user prior to this, however, the user may anticipate such a change in QoE and be able to remedy the situation or be prepared for the drop in QoE. It is appreciated that a similar process may be conducted by the peripheral device workspace telemetry module for any meeting or event and for any projected QoE change in any device node within any peripheral device workspace. At this point the method 400 may end.

The blocks of the flow diagrams of FIGS. 3 and 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A peripheral device workspace cloud orchestrator server, comprising:
a hardware processor;
a memory device;
a power management unit (PMU) to provide power to the hardware processor and memory device;
a network interface device to receive quality of experience (QoE) values, user identification data, and node device enrollment data associated with a plurality of device nodes within a peripheral device workspace;
the hardware processor to execute computer-readable program code of a peripheral device workspace telemetry module to save the QoE values, user identification data, and node device enrollment data on a cloud orchestrator database; and
the hardware processor to execute the computer-readable program code of a peripheral device workspace telemetry module to:
request and receive upcoming user meetings and events associated with the user's use of the plurality of device nodes in the peripheral device workspace that are affected by the QoE values;
analyze trends regarding the meetings and events and provide projections indicative of the QoE values affecting the QoE during the meetings and events; and
generate unified workspace notifications that indicate the QoE will be affected at one or more of the plurality of device nodes within the peripheral device workspace and sending those unified workspace notifications to the anchor information handling system node within the peripheral device workspace.

2. The peripheral device workspace cloud orchestrator server of claim 1 further comprising:
the hardware processor executing computer-readable program code of a cloud orchestrator notification module to transmit the unified workspace notifications to the anchor information handling system node.

3. The peripheral device workspace cloud orchestrator server of claim 1 further comprising:
the hardware processor executing computer-readable program code of an ecosystem manageability service module to receive device node data indicating operational relationships between the anchor information handling system node and a plurality of peripheral device nodes in a manifest of the device nodes, define the peripheral device workspace comprising the anchor information handling system node and peripheral device nodes at an identified location, assign a peripheral device workspace identification value to the defined peripheral device workspace, save the peripheral device workspace identification value on the cloud orchestrator database, and associate the peripheral device workspace with a user of the anchor information handling system node.

4. The peripheral device workspace cloud orchestrator server of claim 1 further comprising:
a peripheral device server notification gateway to relay and publish alerts for the QoE values relative to a threshold for the QoE values currently to the anchor information handling system node, smart device nodes, and peripheral device nodes.

5. The peripheral device workspace cloud orchestrator server of claim 1, wherein the QoE values are determined from levels of processing resources, memory resources, and battery power resources at the plurality of device nodes.

6. The peripheral device workspace cloud orchestrator server of claim 1 further comprising:
the hardware processor to execute computer code of a cloud manageability orchestrator module to link the peripheral device workspace identification value with a user composite peripheral device workspace identifier that identifies a user of the anchor node information handling system within the peripheral device workspace identified by the peripheral device workspace identification value.

7. The peripheral device workspace cloud orchestrator server of claim 1, wherein the hardware processor receives the device enrollment data for the plurality of peripheral device nodes from an anchor node information handling system node including a hardware processor executing an ecosystem manageability sub-agent that gathers the QoE values, user identification data, and node device enrollment data for transmission to the peripheral device workspace cloud orchestrator server.

8. The peripheral device workspace cloud orchestrator server of claim 1 further comprising:
a peripheral device workspace cloud orchestrator console graphical user interface operatively coupled to the could orchestrator server to receive input from an internet technology decision maker (ITDM) to review the node device enrollment data describing one or more peripheral device nodes of a peripheral device workspace and to create the hardware device operational policies that define the peripheral device workspace with the one or more peripheral device nodes forming part of the peripheral device workspace.

9. A method of providing unified workspace level alerts to a device node within a peripheral device workspace comprising:
receiving, at a network interface device of a peripheral device workspace cloud orchestrator server, quality of experience (QoE) values, user identification data, and node device enrollment data associated with a plurality of device nodes within a peripheral device workspace, the plurality of device nodes including an anchor information handling system node, one or more smart device nodes, and one or more peripheral device nodes;
with a hardware processor of the peripheral device workspace cloud orchestrator server, executing computer-readable program code of a peripheral device workspace telemetry module for:
saving the QoE values, user identification data, and node device enrollment data on a cloud orchestrator database;
requesting and receiving upcoming user meetings and events associated with the user's use of the plurality of device nodes that are affected by the QoE values;
analyzing trends and providing projections indicative of the QoE values affecting the QoE during the meetings and events; and
generating unified workspace notifications that the QoE will be affected at one or more of the device nodes within the peripheral device workspace and sending those unified workspace notifications to the anchor information handling system node within the peripheral device workspace.

10. The method of claim 9 further comprising:
with the hardware processor of the peripheral device workspace cloud orchestrator server, executing computer-readable program code of a cloud orchestrator notification module to transmit the unified workspace notifications to the anchor information handling system node.

11. The method of claim 9 further comprising:
with the hardware processor of the peripheral device workspace cloud orchestrator server, executing computer-readable program code of an ecosystem manageability service module to receive device node enrollment data describing operational connectivity and operational component metrics between the anchor information handling system node and peripheral device nodes in the peripheral device workspace, define the peripheral device workspace at an identified location comprising the anchor information handling system node and peripheral device nodes, assign a peripheral device workspace identification value to the defined peripheral device workspace, save the peripheral device workspace identification value on the cloud orchestrator database, and associate the peripheral device workspace with a user of the anchor information handling system node.

12. The method of claim 9 further comprising:
relaying and publishing alerts relating to QoE values to the anchor information handling system node, smart device nodes, and peripheral device nodes via a peripheral device server notification gateway.

13. The method of claim 9, wherein the QoE values includes levels of processing resources, memory resources, and battery power resources for the node devices in a peripheral device workspace.

14. The method of claim 9 further comprising:
with the hardware processor of the peripheral device workspace cloud orchestrator server, executing computer-readable program code of a cloud manageability orchestrator module to link the peripheral device workspace identification value with a user composite peripheral device workspace identifier that identifies a user of the anchor node information handling system within the peripheral device workspace identified by the peripheral device workspace identification value.

15. The method of claim 9, wherein the hardware processor receives the device enrollment data from an anchor node information handling system node including a hardware processor executing an ecosystem manageability sub-agent that gathers the QoE values, user identification data, and node device enrollment data for transmission to the peripheral device workspace cloud orchestrator server.

16. A peripheral device workspace cloud orchestrator server, comprising:
a hardware processor;
a memory device;
a power management unit (PMU) to provide power to the hardware processor and memory device;
a network interface device to receive quality of experience (QoE) values, user identification data, and node device enrollment data associated with a plurality of device nodes within a peripheral device workspace, the plurality of device nodes including an anchor information handling system node, one or more smart device nodes, and one or more peripheral device nodes;
the hardware processor executing computer-readable program code of an ecosystem manageability service module to receive device node enrollment data describing operational relationships between the anchor information handling system node and peripheral device nodes, define the peripheral device workspace at a location comprising the anchor information handling system node and peripheral device nodes in a peripheral device workspace manifest, assign a peripheral device workspace identification value to the defined peripheral device workspace, save the peripheral device workspace identification value on the cloud orchestrator database, and associate the peripheral device workspace with a user of the anchor information handling system node;
the hardware processor to execute computer-readable program code of a peripheral device workspace telemetry module to save the QoE values, user identification data, and node device data on a cloud orchestrator database; and
the hardware processor to execute the computer code of a peripheral device workspace telemetry module to:
request and receive indications of upcoming user meetings and events associated with the user's use of the plurality of device nodes that are affected by the QoE values;
analyze trends and provide projections indicative of the QoE values affecting the QoE during the meetings and events; and
generate unified workspace notifications that the QoE will be affected at one or more of the device nodes within the peripheral device workspace during the upcoming user meetings and events and sending those unified workspace notifications to the anchor information handling system node within the peripheral device workspace.

17. The peripheral device workspace cloud orchestrator server of claim 16 further comprising:
the hardware processor executing computer-readable program code of a cloud orchestrator notification module to transmit the unified workspace notifications to the anchor information handling system node.

18. The peripheral device workspace cloud orchestrator server of claim 16 further comprising:
a peripheral device server notification gateway to relay and publish alerts relating to QoE values to the anchor information handling system node, smart device nodes, and peripheral device nodes.

19. The peripheral device workspace cloud orchestrator server of claim 16, wherein the QoE values includes levels of processing resources, memory resources, and battery power resources for node devices in the peripheral device workspace.

20. The peripheral device workspace cloud orchestrator server of claim 16, wherein the hardware processor receives the node device enrollment data from an anchor node information handling system node including an anchor node information handling system hardware processor executing an ecosystem manageability sub-agent that gathers the QoE values, user identification data, and node device enrollment data for transmission to the peripheral device workspace cloud orchestrator server.
